(19) United States
(12) Patent Application Publication
(10) Pub. No.: US 2024/0233367 A1
(43) Pub. Date: Jul. 11, 2024

(54) METHODS, DEVICES, AND SYSTEMS FOR SENSOR AND SATELLITE AI FUSION

(71) Applicant: N5 SENSORS, INC., Rockville, MD (US)

(72) Inventors: Abhishek MOTAYED, Rockville, MD (US); Dennis TRIMARCHI, Frederick, MD (US)

(21) Appl. No.: 18/409,108

(22) Filed: Jan. 10, 2024

Related U.S. Application Data
(60) Provisional application No. 63/479,233, filed on Jan. 10, 2023.

(51) Int. Cl. G06V 20/13; G01S 13/90; G01W 1/00

(52) U.S. Cl. CPC G06V 20/13; G01S 13/90; G01W 1/00

(57) ABSTRACT

Methods, devices, and systems for sensor and satellite AI fusion to detect changes in the environment, e.g., fire, smoke, chemicals, gasses, etc. and to pinpoint a specifical geographical location of those changes.

### RELATED APPLICATION

This application is related to, and claims priority from U.S. Provisional Patent Application No. 63/479,233, filed on Jan. 10, 2023, entitled “Satellite Imagery Integration With N5Shield,” the entire disclosure of which is incorporated here by reference.

### BACKGROUND

Extreme weather events, including forest wildfires, are occurring more frequently in recent years. Various related environmental factors result in longer fire seasons, bigger fires, and wildfires in areas not typically prone to these events. Wildfires can spread rapidly and erratically, causing damage and posing danger to the surrounding environment, wildlife, homes, communities, natural resources, and people. Wildfires are becoming more difficult to manage, making it challenging for firefighters to respond and deploy limited resources promptly, efficiently, and safely. They cause both direct and indirect financial and environmental losses, including greenhouse gas emissions. Wildfires also impact the health and well-being of populations due to resultant poor air quality, especially those who are in socio-economically disadvantaged areas. However, current solutions have proven to be insufficient.

Currently, the U.S. Forest Service (USFS) spends +$3B every year fighting wildfires. These costs are increasing annually and make up almost half of the forest service's budget. The costliest fire in U.S. history, the Camp Fire of 2018, caused an estimated $10B in insured losses in 2018. Thus, the early detection and accurate location of a fire at the earliest stages of ignition is essential when it comes to mitigating fire damage. Equally important is the prediction of the fire behavior to inform precise firefighting strategies that are tailored for the topography and micro weather conditions. More accurate, higher fidelity, and robust information will enable efficient use of resources and therefore reduce the risks and losses associated with wildfires. For the detection and location of wildland fires, several technologies are being used today, as shown in Table 1.

TABLE 1
Cameras, satellites, ground-based tools and the various predictive
analytics all help, but they are not enough to prevent fires.

| | | | Ground Based |
|---|---|---|---|
| | Satellites | Camera | Sensors |
| Detection Speed | Slowest (12 | Slow | Fast |
| | to 24 hours) | (Several Hours) | |
| Total Cost of | High | High | Low |
| Protection | | | |
| Air Quality | No | No | Yes |
| Measurement | | | |
| All Weather | Clear | Clear Visibility | Yes |
| Operation | Visibility | and Line of Sight | |
| Autonomy | Human | Human Analysis | Potentially Fully |
| | Analysis | unless powered | autonomous |
| | | by AI | powered by AI |
| False & Missed | Medium | Medium | Low Risk |
| Alerts | | | |
| Scalability | Medium | Low | Medium-High |

Other vendors working in the forest and wildland fire detection area are shown in Table 2. Table 3 contrasts technical approaches to fire detection. The N5 technology enables reduced cost, size, and power while maintaining robustness due to the all-semiconductor platform.

TABLE 2
Competitive technologies and other companies.

| Alert Wildfire | Camera Based | Non-Profit |
|---|---|---|
| Orora | Cube Satellite-Based | Latency and Resolution Could |
| Technology | IR Imaging | be Potentially Game Changer |
| | | in Fire Detection |
| PanoAI | AI with Pan-Zoom-Tilt | Extensive Installation |
| | Camera | Requirements |

TABLE 3
N5's competitive Landscape.

| | | | Ground | | |
|---|---|---|---|---|---|
| | | | Based | | |
| | | | “Smoke” | | |
| | Satellites | Camera + AI | Sensors | N5SHIELD | SSF Fire AI |
| Detection: | L- Mapping | M-L | M-L | S-L, location, | S-L, |
| (S/M/L fires) | fire lines | | | & tracking | location & |
| | | | | | prediction |
| Companies | Orora | Alert Wildfire, | Dryad | N5 Sensors | N5 Sensors |
| | Technology | Alchera, PanoAI | | | |
| Detection | Slowest (12 to | Slow (Several | Fast | Fastest (<15 | <5 minutes |
| Speed | 24 hours) | Hours) | | minutes) | |
| Total Cost of | High | High | Low | Low | Low |
| Protection | | | | | |
| Air Quality | No | No | Possible | Yes | Yes |
| Measurement | | | | | |
| All Weather | Clear Visibility | Clear Visibility | Yes | Yes | Yes |
| Operation | Only | and Line of | | | |
| | | Sight | | | |
| Autonomy | Human | Human Analysis | Potentially | Fully | Yes |
| | Analysis | unless powered | | autonomous | |
| | | by AI | | powered by AI | |
| False & | Medium | Medium | High Risk | Very Low | Very Low |
| Missed Alerts | | | | Risk | Risk |
| Scalability | Medium | Low | Low | High | High |

Cameras, satellites, ground-based tools, and various predictive analytics all help, but they are not enough to rapidly detect and manage forest and wildland fires. This presents a critical need for innovations that could offer improved decision-making tools so that firefighters can respond to wildfires earlier, faster, safer, and more efficiently to mitigate spread and damage. Such a solution would: (1) enhance the protection of U.S. forested lands and resources from wildfires; (2) ensure the continued existence of healthy and productive forest ecosystems; and (3) improve the environmental safety and economic security of the surrounding communities.

Thus, to solve the current issues above, embodiments disclosed herein provide a platform that combines ground-based artificial intelligence (AI) powered fire detection sensor networks with real-time satellite imagery to provide firefighters with key actionable insights, namely for rapid detection, prediction of fire evolution, and mitigation strategies.

### SUMMARY

According to an embodiment, a method for environmental condition detection, wherein the method comprises: obtaining baseline images for a geographical area; detecting, by at least one sensor, environmental conditions in a portion of the geographical area; and confirming a presence of a specific environmental condition detected by the at least one sensor in the portion of the geographical area using the baseline images.

According to an embodiment, an apparatus for performing environmental condition detection, the apparatus comprising: at least one processor; a display; and a memory, wherein the at least one processor is configured to: receive baseline images for a geographical area; receive, from at least one sensor, detected environmental conditions in a portion of the geographical area; and confirm a presence of a specific environmental condition detected by the at least one sensor in the portion of the geographical area using the baseline images.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 illustrates a satellite-sensor AI fusion system according to an embodiment;

FIG. 2 illustrates a device for detecting conditions in an environment according to an embodiment;

FIG. 3 illustrates a sensor package in the device according to an embodiment;

FIG. 4 illustrates a radio according to an embodiment;

FIG. 5 illustrates a system according to an embodiment;

FIG. 6 illustrates a pipeline implementation according to an embodiment;

FIG. 7 illustrates a mapping of results from FIG. 6;

FIG. 8 illustrates a structure of API-based satellite image time series (SITS) acquisition according to an embodiment;

FIG. 9 illustrates a method according to an embodiment; and

FIG. 10 illustrates a device according to an embodiment.

### DETAILED DESCRIPTION

The embodiments are more fully described herein with reference to the accompanying drawings, in which embodiments of the inventive concept are shown. In the drawings, the size and relative sizes of layers and regions may be exaggerated for clarity. Like numbers refer to like elements throughout. The embodiments may, however, be embodied in many different forms and should not be construed as limited to the embodiments set forth herein. Rather, these embodiments are provided so that this disclosure will be thorough and complete, and will fully convey the scope of the inventive concept to those skilled in the art. The scope of the embodiments is therefore defined by the appended claims.

Reference throughout the specification to “one embodiment” or “an embodiment” means that a particular feature, structure or characteristic described in connection with an embodiment is included in at least one embodiment of the present invention. Thus, the appearance of the phrases “in one embodiment” or “in an embodiment” in various places throughout the specification is not necessarily all referring to the same embodiment. Further, the particular features, structures or characteristics may be combined in any suitable manner in one or more embodiments.

As used herein, the singular forms “a”, “an”, and “the” are intended to include the plural forms as well, unless the context indicates otherwise. In the specification and the claims, the term “and/or” is intended to include any combination of the terms “and” and “or” for the purpose of its meaning and interpretation.

Embodiments described herein provide a platform that combines ground-based artificial intelligence (AI) powered fire detection sensor networks with real-time satellite imagery to provide firefighters with key actionable insights, namely for rapid detection, prediction of fire evolution, and mitigation strategies.

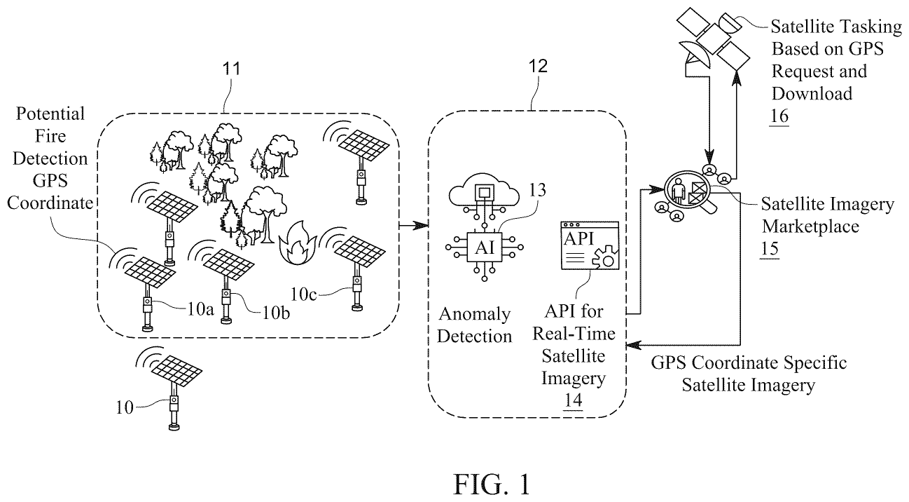

The Satellite-Sensor Fusion Fire AI (SSF Fire AI) system, shown conceptually in FIG. 1, provides a turn-key solution composed of a platform sensor suite with edge analytics that informs the cloud-based, fire-detect AI engine of fire ignition and location. The system automatically uses an application programming interface (API) to acquire time series satellite imagery to determine the exact location, and then “tasks” an appropriate satellite network to acquire new images. The combination of proven ground-based fire detection sensor networks with satellite imagery using a machine learning (ML) model enables the analysis of time series imagery to detect anomalies. Satellite image data in multiple spectral bands (e.g., visible, infrared, microwave) will provide critical data even under challenging environmental, terrain, and weather conditions. As such, the system accomplishes the early detection and management of wildfires on forest lands. The fusion of satellite imagery and a state-of-the-art ground-based sensor network using the latest AI algorithms offers a wildfire management tool that does not currently exist. The SSF Fire AI will offer firefighters actionable information to respond to wildfires much earlier, faster, and efficiently to mitigate the spread of wildfire and reduce risks.

As shown in FIG. 1, there is at least one multimodal sensor node 10, which can form part of the ground-based sensor network 11, which includes multiple sensor nodes 10a, 10b, 10c, etc. The multimodal sensor node can detect fire, smoke, wind, and other chemicals or gases and communicate this information to the anomaly detection network 12, which may comprise a cloud-based AI 13 and API 14, which can perform machine learning algorithms. The anomaly detection network 12 is either already aware of the GPS coordinates of the sensor node 10 or the sensor node 10 sends this information to the anomaly detection network 12. The API 14 can be used to obtain real-time satellite imagery by communicating with the satellite imaging marketplace 15 so that the API 14 can receive GPS coordinate specific satellite imagery or can task the satellite 16 to provide further imagery based on GPS coordinates. This tasking of the satellite 16 to provide further imagery can entail a time-series of images, where multiple images in a short period of time (e.g., every ten minutes) can be obtained and sent to the API 14.

The sensor network 11 during deployment triggers baseline image collection from various satellites 16. Various spectral images can be utilized such as, visible, infrared, and Synthetic aperture radio (SAR) images. When a small fire starts, the sensor network 11 detects the fire signature. The cloud-based AI 13 and API 14 use GPS coordinates to search available images from various satellites 16 and different types of images (e.g., optical, infrared, synthetic aperture radio, etc.). Once an appropriate sample is available from geospatial imagery from various sources, e.g., GOES, LEO, Copernicus, Himawari, the AI, and API can then verify and confirm any anomalies. Once verified, an automated message is sent to various community emergency teams.

With this specific implementation, a fire detection system, running on GOES (Geostationary Earth Observing Satellite) https://www.goes.noaa.gov/ can be made available. By using Convolutional Neural Networks (CNN) enabled change detection, small fires can be detected that are missed by GOES algorithmic methods (fires smaller than 988 acres). Further, this embodiment provides the ability to detect small fires (early-stage fires) with minimum false alerts, having a size between 2.5 and 250 acres. In addition, fire boundary sizes may be accurately determined with super-resolution and performing downscaling.

A ground-based sensor node detects classes of chemical that represents anomaly in the environment in excess of various thresholds (concentration over normal) and determines that there is a potential fire event or chemical spill. The AI can estimate the baseline of different chemical makeups of different environments such as outdoor, indoor (metro station, subway, airport), industrial facilities, shipyards, oil and gas operations, mining, agricultural operations etc. AI continuously learns what is normal and then can detect anomalies. This can be chemical, thermal signature of the scene, can be particulate signature (aerosol present in the environment), vibration/shock (to indicate land slide, earthquakes), noise profile (to indicate gun shot, explosion). By including other sensors, the list can be expanded, like flooding, etc.

The ground-based sensor node tasks the satellite system to take images based on the sensor node's GPS coordinates. The satellite system can take a single image, or whatever is available within 30 seconds of a recorded event, and can capture multiple images in a set duration. For example, a set duration could be obtaining an image by the satellite system every five minutes for the next 30 minutes after the recorded event. The satellite system transmits the images to the AI ML server for processing. The API will the retrieve images and store them in the database for processing by the AI. The AI ML server processes the images to confirm/deny a potential fire event. The data is visualized in a web-based or mobile application overlaid on top of GIS maps with the ground-based sensor network visualized.

Although some embodiments below discuss satellite-sensor fusion with AI for fire detection, this satellite-sensor fusion AI system can be used for detecting multiple environmental conditions and anomalies. These environmental conditions could be floods, fires, earthquakes, landslides, chemical attacks, chemical spills, workplace accidents, biological attacks, shootings, terrorist attacks, bombings, etc.

Embodiments disclosed herein, and described above, combine complementary information from ground-based sensors with the high accuracy and resolution of satellite imagery. On-demand time series analysis of satellite imagery from a specific area of interest is fetched using an API automatically using GEO (geostationary) location specifics from ground-based sensors. ML models are developed to use time series data, and also multispectral imagery to identify fire-related anomalies and reject other types of changes (e.g., automobiles, agricultural operations). Accordingly, a fuller description of various types of satellite imagery techniques and systems and aspects of the ground-based sensor network that can be used in conjunction with the embodiments is now provided.

### Satellite Imagery

Currently, there are several NASA and NOAA satellites with different on-board instrumentation used in fire detection as noted in Table 4. Using satellites to detect hotspots was first documented by Michael Matson and Jeff Dozier in the American Society of Photogrammetry (1981). Here, they used 3.8- and 11-micron thermal infrared channels onboard a NOAA-6 environmental satellite to estimate the size and temperature of the hot spots on the ground. The orbits of Earth-observation satellites generally fall into one of two categories: GEO and LEO (low Earth orbit). GEO satellites are ˜36,000 km above the equator, where they circle in sync with Earth's rotation. Satellites in LEO are closer to the ground, allowing them to obtain higher-resolution images. Such satellite data was used to create Fire Information for Resource Management Systems (FIRMS), which is a joint effort by NASA and the USDA Forest Service, to provide access to low latency satellite imagery and science data products from the Earth Observation System (EOS) satellite assets to identify the location, extent, and intensity of wildfire activity and effect. However, their satellite-based image analysis is non-specific and can only analyze burn areas.

TABLE 4
A summary of the instruments and U.S. Govt. satellites used for fire detection today.

| | | Spatial | Temporal | |
|---|---|---|---|---|
| Satellite | Instrument | Resolution | Resolution | Agency |
| Polar Operational | Advanced Very | ~1 km | ~12 hours | NOAA- |
| Environmental Satellites | High-Resolution | | | NASA |
| (POES 19) | Radiometer | | | |
| | (AVHRR) | | | |
| National Polar-orbiting | Visible Infrared Imaging | ~0.37 km | ~12 hours | NASA |
| Partnership (NPP SOUMI) | Radiometer Suite (VIIRS) | | | |
| and NOAA 20 | | | | |
| Landsat 8 | Thermal Infrared Sensor | ~1 km | ~12 hours | NASA- |
| | (TIRS) | | | USGS |
| Terra and Aqua | Moderate Resolution | ~1 km | ~12 hours | NASA |
| | Imaging Spectroradiometer | | | |
| | (MODIS) | | | |
| GEOS 16 (East) and | Advanced Baseline Imager | ~2-4 km | ~5 mins | NOAA- |
| GEOS 17 (West) | (ABI) | | | NASA |

To date, the best commercially available spatial resolution for optical imagery is 25 cm (one pixel represents a 25-by-25-cm area on the ground). Many companies can capture data with 25 cm to 1 meter resolution, which is considered high to very high resolution. Some companies also offer data from 1 meter to 5 meters resolution, which is considered medium to high resolution. Several government programs have made optical data available at 10 meters, 15 meters, 30 meters, and 250 meters resolutions for free with open data programs (i.e., NASA/US Geological Survey Landsat, NASA Moderate Resolution Imaging Spectroradiometer, ESA Copernicus). There are a variety of ways in which a satellite captures an image. Some imaging satellites capture data outside of the visible-light spectrum using the near-infrared band (widely used in agriculture). However, there are some disadvantages with infrared as it might be challenging to penetrate objects to capture a clear view of the Earth surface. Longer-wavelength “thermal” IR can penetrate smoke and identify heat sources, which is valuable to monitor fires but these images can also be difficult to interpret due to erratic temperature fluctuations, and the systems are costly. Synthetic aperture radar (SAR) is becoming a more popular method to obtain accurate satellite imagery at 25 cm resolution. Notably, SAR can penetrate through most objects (e.g., rain, clouds) to capture an image which is useful for anomaly detection. Thus, SAR is a viable approach for embodiments disclosed herein, to use for the satellite-sensor data fusion concept for wildfire detection.

### Ground-Based Fire Detection Network

An exemplary embodiment uses a multimodal sensor system 11 that integrates orthogonal sensors for the detection of wildfires, as well as environmental and toxic gases.

The N5SHIELD™ is a cloud-connected network of sensor nodes (ChemNode™) with integrated device, data, and decision support tools to provide end-to-end solutions, data analysis, reporting, and communication features including: AI and intuitive software technology to provide automatic detection and verification of fire ignitions within coverage areas; capability to confirm fire ignitions within the first few minutes following a fire; automatic notification and dissemination of the information to authorities and other appropriate agencies; and instant access to a timelapse of all captured and live data for all fire stages. The sensor nodes continuously analyze particulate matter, chemical makeup, and IR heat signatures and send data using available communication channels to the cloud-based AI engine. The AI engine identifies the signature of a fire, generates alerts and can also map and track fire movement.

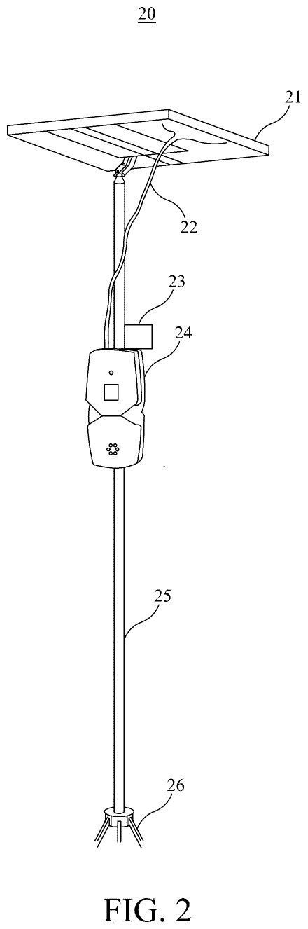

According to an embodiment, there is a device 20, as shown in FIG. 2. Device 20 (i.e., sensing device, sensor node) can include a sensor package 24, a solar panel 21, and a radio 23. FIG. 2 also shows a stand 25 to which the sensor package 24, the solar panel 21, and the radio 23 are mounted. The stand or tripod 25 can also be configured to stand on or otherwise be mounted to a surface, e.g., ground 26 or a portion of a building. While shown in FIG. 2 as a single piece, the stand 25 can be formed in a variety of manners to include multiple pieces to allow the stand 25 to be deployed in a plurality of locations. For example, the stand 26 can be placed outdoors, or a shortened version of the stand 26 can be mounted indoors. Further, while not shown separately in FIG. 2, a battery can be included as a part of the solar panel 21, as a portion of the sensor package 24, or as its own entity, which can then also be attached to the stand 25. Further, a power cable 22 can attach the solar panel 21 to the sensor package 24 or to one or more batteries. Although the sensor package 24 appears to be mounted well above the ground level, the sensor package 24, and/or the sensing device 20 could be located immediately above the ground, e.g., between 5 and 30 feet above ground elevation. Further, the sensor package 24 could be mounted to a drone, such as an unmanned aerial vehicle (UAV) or an unmanned ground vehicle (UGV). When the sensor package 24 is mounted to a drone, the sensing device 20 could be located just a few inches from the ground or several feet above the ground.

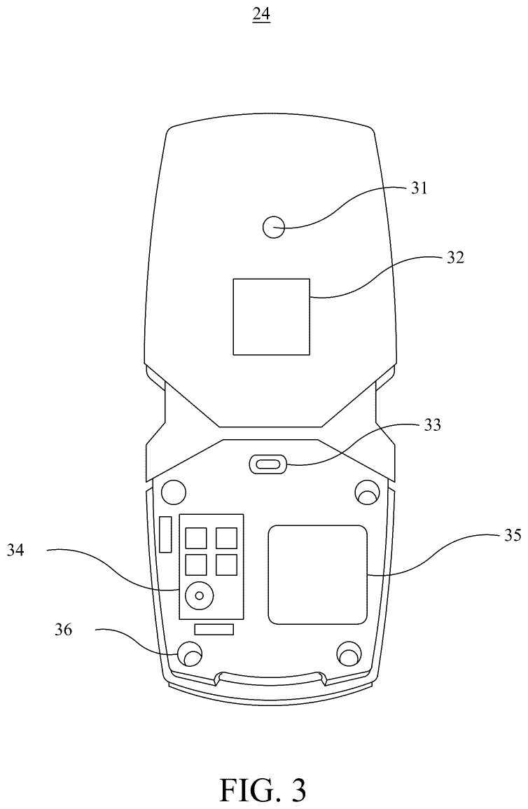

According to an embodiment, FIG. 3 shows the sensor package 24, which is now described in more detail. According to an embodiment, the sensor package 24 can include one or more of the following features: an infrared array sensor 31, an e-paper screen 32, a universal serial bus (USB) 33, a particle monitor 35, a gas sampling feature 34 and a multiple gas sensor array 36 which can be configured to detect one or more gases in the environment. The infrared array sensor 31 can be an off-the-shelf infrared camera or other type of infrared detector with various sized viewing angles, e.g., a 60-degree viewing angle. The infrared array sensor 31 can be used to identify point sources of heat that are within the unit line of sight. The e-paper screen 32 can be an ultra-low power screen which can be used to interface with the sensor package 24 on-site. The USB 33 can be a USB-C as well as representing other desired types of connectivity functions. Further, the device 20 and/or sensor package 24 can be configured to include another camera which may be configured to capture images in a visible light spectrum. The e-paper screen 32 can also allow for the use of QR codes. For example, a companion application running on a mobile phone, or other device, can be used to onboard the device in a system by using the QR code displayed on the screen, which can contain the serial number of the device and other details. Also, the e-paper screen 32 can show working conditions such as battery power, and to which communication network the node is currently connected, as well as describing failure codes for assistance with field diagnostics.

According to an embodiment, the particle monitor 35 can be a high sensitivity particle monitor which is used to obtain particle quantities from the local environment. This information can support detection of wildfire smoke/smolder based on checking particle thresholds against an absolute or relative particle measure. The particle monitor 35 can obtain data both rapidly and with a useful sensitivity while maintaining a good correlation to reference TSI mass concentration. The gas sampling feature 34 and the gas sensor array 36 can work together to capture and measure/detect various gas concentrations in the environment around the sensor package 24. More specifically, an array of chemical sensors for gases like NOx, 03 and SOx can be used to improve wildfire detection as compared to only attempting to detect a single gas type. According to an embodiment, the semiconductors used in the gas sensor array 34, combined with desired programming (which can in some cases be modified at a future time to alter the gas combinations to be detected) determine what gases the gas sensor array is currently configured to detect. According to an embodiment, the combination of the various types of sensing devices and monitors are used in the sensor package 24 to create a novel manner for detecting wildfires and/or other desired atmospheric/environment conditions. For example, the sensor package 24 could contain sensors for detecting wind, to help predict which way the fire may be spreading.

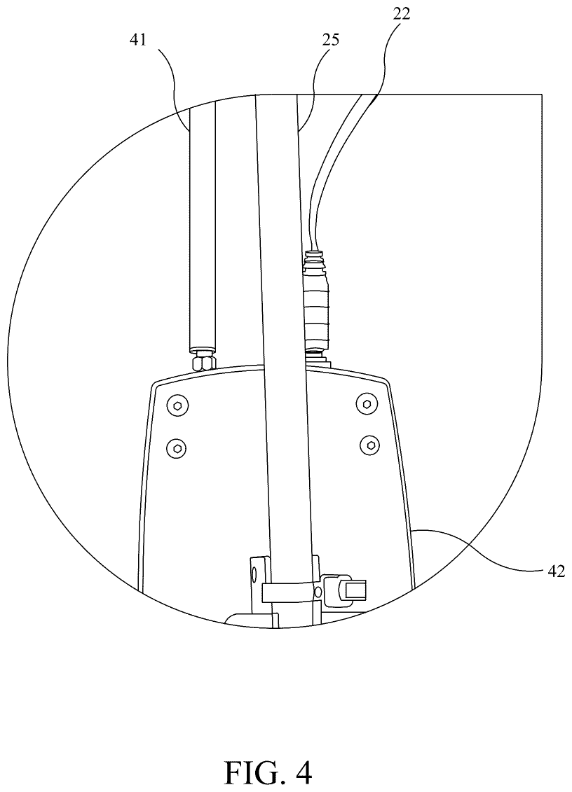

According to an embodiment, device 20 can have a radio as a portion of the device, with the radio 42 shown in FIG. 4. FIG. 4 shows the radio 42, an antenna 41, the stand 25, and the power cable 22. The radio 42 can either be a stand-alone radio function or it can be integrated with another portion of the device, such as the sensor package 24. While using the term “radio” herein to describe the radio 42, it is to be understood by those skilled in the art that the term “radio” is being broadly used herein to also include other devices which perform a similar function for transmitting and/or receiving information, e.g., optical transceivers, etc. For example, the radio 42 can be a low-power radio with a gateway that can support multiple types of backhaul for use in areas without cellular connectivity, or the radio 42 could be a device that uses cellular or satellite connectivity. The radio 42 can be a device that is capable of operating using one or more radio access technologies (RATs). The radio 42 can also be configured to operate in the Industrial, Scientific, and Medical (ISM) frequency bands, which are designated radio frequency bands as defined by the International Telecommunication Union (ITU) Radio Regulations. The most common everyday uses of the ISM bands are for low-power and short-range telecommunications, such as WiFi, Bluetooth and the like for ease of communications to a gateway device.

According to an embodiment, regarding powering the sensing device, in conditions when it is not feasible or desirable to have a traditional power system setup, the device 20 can include a solar panel 21 and a battery 23. The solar panel 21 can be a seventeen-Watt solar panel charger and integrated with a 30,000 milliampere hour (mAH) battery which can operate the device 20 for up to seven days without sunlight. Alternatively, other combinations of types of solar panels 21 and batteries 23 could be used as desired based on the intended operating conditions.

### SSF Fire AI Overview

Embodiments disclose an easy-to-use web-based tool that can be used by various firefighting groups to effectively manage wildfires, and to protect remote communities and those at the wildland-urban interface. The SSF Fire AI provides a unique, turn-key solution composed of a platform sensor suite with edge analytics that informs the cloud-based fire-detection AI engine of the fire location. Notably, SSF Fire AI will have the capabilities to inform firefighters of the (1) probability and risks of a wildland fire occurring, and (2) reliable analytics and predictions of the behavior (i.e., spread, speed) of the wildland fire once it has started. The SSF Fire AI can be rapidly deployed in any terrain to measure a variety of relevant environmental conditions using hyperlocal real-time data. This SSF Fire AI system includes various hardware and software modules for a seamless integration with wireless cloud-based systems capable of monitoring the environment with high fidelity. Firefighters and emergency response personnel can simply use a web-based portal to access key information (e.g., fire detection maps, system-level alerts, predictive maps with fire spread behavior, maintenance alerts) and compile easy-access reports. By leveraging innovations in sensor design, network connectivity, and both edge and cloud analytics, the SSF Fire AI solution will enable high sensitivity, low power consumption, and self-calibration capability, which will reduce the acquisition and operational costs significantly. Finally, the system will be ruggedized to withstand extreme weather conditions. SSF Fire AI will also be deployable with minimum effort to cover the desired spatial scales and with high resolution (less than 1 acre) to map the spatial variation of potentially emerging wildland fire threats with minimum user intervention.

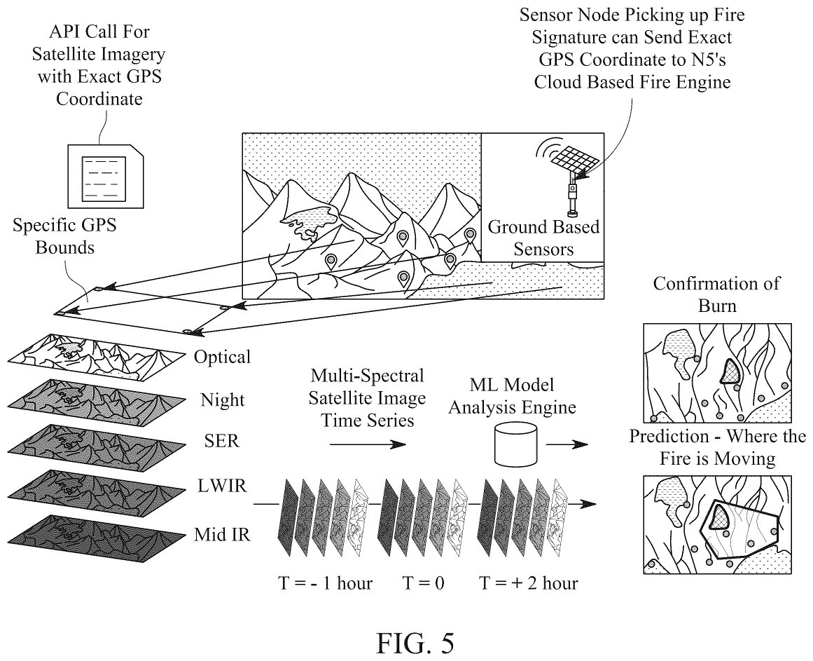

The architecture of the SSF Fire AI is shown in FIG. 5. A ground-based sensor network is deployed that can detect signatures of fire ignition using multimodal sensor fusion. The ground-based sensor network sends the detected signatures to the AI and the exact GPS coordinates. A cloud-based AI engine then uses the GPS coordinates of a specific area where a fire is detected to task API-based satellite image acquisition (a time series of images, where multiple images are acquired over a period of time). The images can be multispectral. Once images are acquired, a separate image processing AI engine, using machine learning, will detect anomalies and provide alerts. The alerts can be predictions of where the fire may spread or confirmation of a fire occurring. By using the ability of the ground-based sensor network to provide a location of a specific area where an anomaly is detected (e.g., an area from 1-20 or 1-200 acres or even less than one acre around a ground sensor or a plurality of ground sensors), the system according to some embodiments is able to reduce the amount of satellite imagery that will be evaluated to confirm (or deny) the presence of a fire (or other environmental condition). When considering that a massive amount of image data is taken by a satellite in a single image over a very large area, the ability of the embodiments to reduce that image data to a smaller region, i.e., less than one acre, 1-20 or 1-200 acres worth of data, enables both higher speed detection and the ability to use higher resolution data.

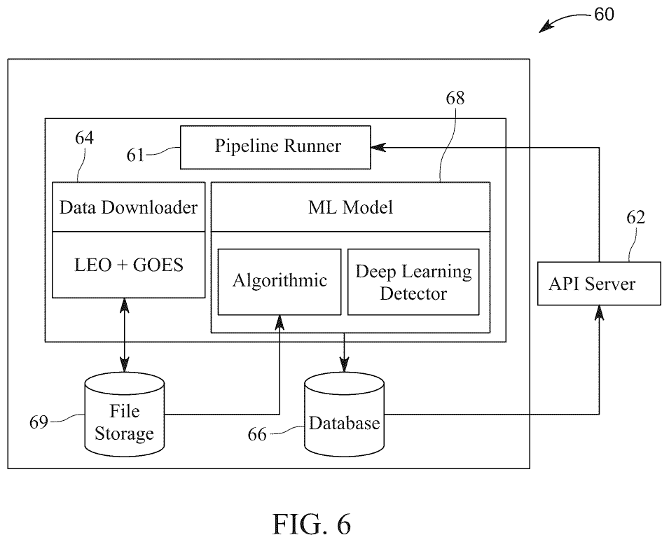

FIG. 6 illustrates an implementation of a pipeline design 60 for the API server 62 and pipeline runner 61 using stored bounding boxes. The data downloader 64 downloads the latest images every hour and chooses the best one based on cloud cover. The data downloader 64 can also download past data from memory 69, when provided with a date interval. The trained ML model 68 makes inferences to detect fire on newly downloaded data. The ML Model 68 can be trained on U.S. fire data. The API server 62 adds new bounding boxes for monitoring by making a call to the geospatial information server (the data downloader 64) with a bounding box request. A map layer for this bounding box is then created. Data download and processing for a region/bounding box for a fixed date interval can be triggered, which is useful for monitoring past fire data. The results are stored in a database 66, which can be queried using an API server 62. The stored bounding boxes can be saved with their extent, name/ID, for example. Upon the API's server 62 query for a bounding box (using its ID), all fire detections will be returned (timestamp, coordinates, confidence).

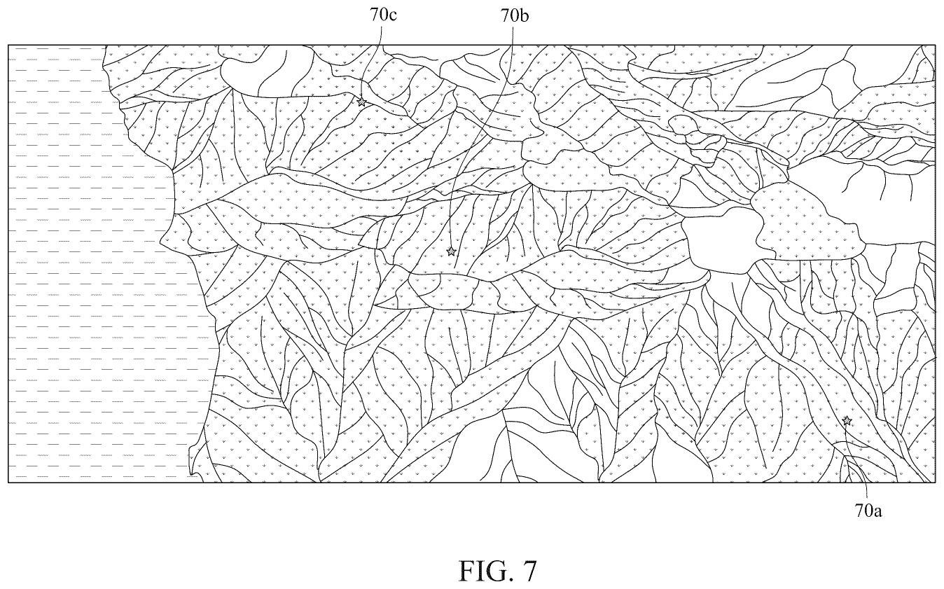

FIG. 7 illustrates an example of the response to the API's server query which provides a map of the geographical locations of the boundary boxes 70a, 70b, 70c, etc. The results to the query can be displayed via a website, webpage, downloadable software on a computer, computing device (wired or wireless), cell phone, etc.

Exemplary embodiments include: (1) hardware and software components to collect and analyze the ground-based and satellite sensor data; (2) an API for tasking and retrieving satellite images; and (3) an AI algorithm model that fuses environmental data collected from the sensors with satellite data to improve the prediction and detection of wildland fire threats and spreading patterns. By doing so, the SSF Fire AI captures the GPS coordinates and uses an API to obtain available satellite data in that location to retrieve time series information to confirm and accurately locate the origin of the fire. Based on the retrieved time series, the system would task the satellite (“tap into”) to gather a time series of satellite images of the targeted location. The ML algorithm overlays and analyzes satellite images to identify anomalies indicative of a fire and correlates this with environmental data detected by the SSF Fire AI. Additional sensor modalities, such as localized wind sensors, can be used so that the SSF Fire AI, with satellite images, can conduct predictive analyses to provide the speed, direction, and progression of a fire. Today, satellites are used for the detection and mapping of the borders of larger wildfires in the U.S., while cameras, ground-based sensors, and 911 callers and aircraft provide a disjointed network for detection. The AI/ML models can be refined through the inclusion and analysis of larger, and historical data sets. The review of larger and historical data sets will also help determine the robustness of the system to various weather conditions, and for use in remote and rugged terrain. Management of wildfires by combining real-time situational awareness with predictive analytics can inform where resources and people should be mobilized to save lives and reduce costs.

Wildfire management is typically viewed as two separate problems: (1) prediction and timely detection of fire and (2) fire containment and mitigation. The present invention provides an integrated system that combines ground-based and satellite-based sensors to provide firefighters with a real-time decision support tool to:
Predict: Based on historical environmental parameters such as windfall, fuel load, fuel moisture, current wind conditions, and current lightning strikes
Detect: Location, size, and speed along with local wind patterns
Respond: Planning, deployment, and logistics

The ground-based sensor networks integrated and fused with satellite imagery data using AI and ML provide for real-time, autonomous fire detection. An advanced AI-based engine requests imagery from one or more satellites and the data is fused to accurately determine the location, spatial extent, and likely evolution and spread of the fire. This will provide actionable intelligence to the forest fire-fighting community so that scarce resources can be deployed effectively. There are several challenges to be met. First, acquiring satellite imagery of a specific area for fire detection is already complicated, is often expensive, and is time-consuming if traditionally acquired. Second, to successfully deploy such a tool, the satellite image must be of high resolution so that anomalies and hotspots will be detected with high accuracy and fidelity. To achieve this, embodiments obtain satellite images according to the GPS coordinates relayed by the SSF Fire AI ground-based sensor network. There will be latency challenges since these images are significantly large files that lead to computational burdens.

For example, one way to perform this type of fire detection is to have the satellite capture an image of a desired location, and then have the satellite pass over the ground station to send the image to the operator for processing and then sent back to the user. These latencies would take anywhere from 12 to 24 hours to complete. To overcome this, embodiments reduce latency by “tasking” the satellite or API to only analyze satellite images according to specific GPS coordinates and time frames based on the SSF Fire AI. Instead of directly asking satellite companies to create the images, an embodiment can use a third-party company that makes the commercial imagery accessible via an API. Using these images, a model will be developed to train the ML model to detect anomalies, hotspots, or artifacts that would indicate a fire based on changes from satellite images overlaid with each other within a certain time period.

There are types and sources of satellite imagery that are appropriate for fire identification, and tracking. Determining what types of satellites and satellite imagery are best suited to accurate fire location and tracking, is based on various factors. Some factors to consider include an assessment of spectral bands, SAR data, resolution, visit frequency, tasking ability, cost per acquisition, and data transfer latency. The key challenge is to identify the best types of live satellite imagery, at an economical cost, and frequency suitable for ML models to identify anomalies associated with fires. Apart from NASA and NOAA LEO satellites, there are many commercial satellite imagery datasets available as archives, as well as operators that allow satellite tasking on a specific area of interest (AOI) using APIs as set forth in Table 5, for example.

TABLE 5
Partial List of Commercial Satellite Sources.

| | | | Imaging | Tasking |
|---|---|---|---|---|
| Company | Type | Types of Satellites | Modes/Resolution | Capability |
| Airbus | Satellite | Pléiades Neo, | Optical/IR | Tasking |
| | Operators | Pléiades SPOT 6/7, | | |
| | | TerraSAR | | |
| Capella | | Capella SAR Leader | SAR | API Tasking |
| | | in Commercial SAR | | |
| | | Satellites | | |
| Planet | | Planet Scope (130 | Optical/Radar/SAR | Tasking |
| | | Satellite constellation) | | Capability |
| Maxar | | Worldview 2 and 3 | SAR | 2 revisits/day |
| Satellogic | | 17 Satellite | Optical/SAR/IR | 4 revisits per day |
| | | constellation | | of Area of |
| | | | | interest in |
| | | | | any point on |
| | | | | earth |
| Head Aerospace | | 86 Earth Observing | Optical/IR/SAR | 5 mins revisits for |
| | | satellites | | some sats |
| Satellite | Imagery | Airbus, Capella, | Optical/IR/SAR | API based |
| Imaging | Market | Planet, Maxar, AT, | | Request from |
| Corporation | Place, | Satellogic, Head | | Archive and |
| UP42 | Value | Aerospace | | Tasking |
| Skywatch | Added | | | |
| | Resellers | | | |

Although optical and IR imagery is currently being used to produce near real-time (NRT) fire detection products such as FIRMS, there are limitations to such satellite detection schemes. For example, during the Tunnel Fire in April 2022, FIRMS was unable to show any fire signature in the area, whereas ground data showed about 19 thousand acres burned. There could be several reasons for this shortcoming such as cloud-cover, latency, instrument being offline, etc. As an alternative to using optical (visible and infrared) satellite images, some embodiments disclosed herein assess the use of SAR which utilizes the microwave region of the electromagnetic spectrum. Operating over a wider spectral range, and at longer wavelengths, SAR provides unique features. In particular, SAR enables viewing through clouds and penetration of dense vegetation. Interrogation in different SAR “Bands” (wavelength regimes) provides a variety of data of potential relevance to the SSF Fire AI. In addition, the nature of SAR allows interferometry (referred to as InSAR) which exploits the phase information inherent in any optical measurement. Thus, this means that InSAR could be used to detect changes in surface topography, which could be an important piece of additional data for the predictive analytics models when working in rugged and uneven forest terrain. In 2020, Yifang Ban, et. al., demonstrated the potential of Sentinel-1 SAR time series with a deep learning framework for near real-time wildfire progression monitoring. Results show that Sentinel-1 SAR backscatter could detect wildfires and capture the temporal progression as demonstrated for three large, impactful events: the 2017 Elephant Hill Fire in British Columbia, Canada; the 2018 Camp Fire in California; and the 2019 Chuckegg Creek Fire in northern Alberta, Canada. These findings demonstrate that spaceborne SAR time series with deep learning play a significant role in near real-time wildfire monitoring, compared to the more conventional optical and IR imagery. Recent advances in API-based tasking and delivery streamline this process, making it easier to obtain and analyze images and data. Table 6 shows examples of free open sources for satellite images considered to provide the data best suited to detect fire anomalies.

TABLE 6
Free open sources and APIs that N5 will review to decide the most
appropriate satellite imagery for fire detection training sets.

| Provider | Description | API Name | Description |
|---|---|---|---|
| MeteoEye | MeteoEye interactive data | Amentum | Accurate data on density, |
| | provision service from the | Atmosphere | composition, and temperature |
| | meteorological satellites | | of the Earth's atmosphere |
| | (TERRA, AQUA, Feng-Yun 3D, | | based on the NRLMSISE-00 |
| | series MetOP and NOAA) in | | model in Jason format. |
| | near real-time. | | |
| Planet | A RESTful service that provides | SkyWatch | Specializes in capturing and |
| Analytics | programmatic access to | | providing accessibility to |
| | interface with Planet Analytic | | satellite data. Allows to |
| | Feeds. Can search and retrieve | | retrieve remote sensing |
| | analytic results. | | datasets for consumption. |
| r2server | LEO satellite data | NASA GIBS | Offers access to high- |
| | | | resolution satellite images in a |
| | | | tile pyramid format. |

An API for tasking a satellite to acquire, compute, and send images based on GPS coordinate data from one or more sources from the ground-based sensor network is used in embodiments disclosed herein. Embodiments herein can leverage an existing platform such as UP42 as the acquisition and tasking API infrastructure. The wide variety of geospatial datasets provided by UP42 (reseller of satellite imagery from multiple sources using API access) will allow embodiments herein to combine datasets to increase both temporal and spatial resolutions, to get better insights over a specific area. APIs are used both for acquiring training data and also for validation.

The satellite data files are normally quite large (over 1 GB for a single large geotiff image), which leads to long processing times. In embodiments herein, unsupervised learning (e.g., ML) can be used, which allows the algorithms to analyze unlabeled datasets and does not require the need for human intervention. A supervised learning approach is not as viable since there are common data mining problems with classification and regression. Using ML requires a creative approach to image analysis. For example, an infrared layer of the source images can be utilized to look for changes/movement in the thermal image.

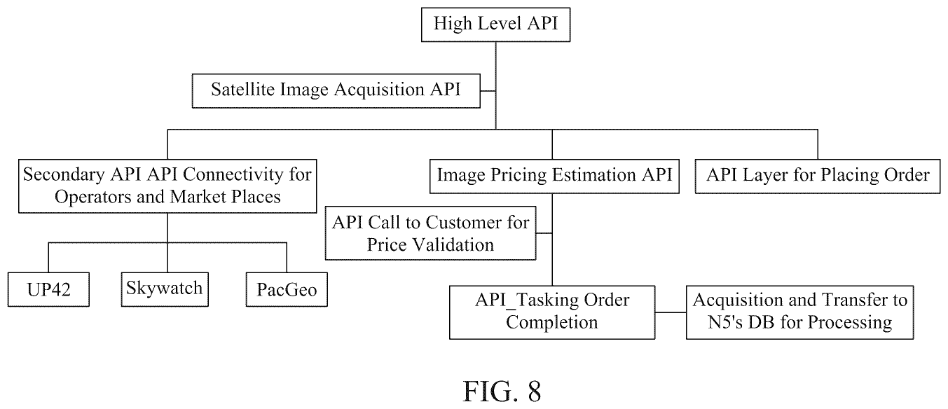

Many conventional weather maps already feature an infrared satellite layer. The API development will go hand in hand with ML model development for training. The structure of API-based SITS (Satellite image time series) acquisition (archive or tasking) is shown in FIG. 8.

The main aspects of API-based access are shown in Table 7.

TABLE 7
Main aspects of API-based access.

| | |
|---|---|
| Collection | A collection is a stack of images that have been captured by a particular |
| | sensor (satellite, aircraft, balloon, etc.). Collections are separated |
| | according to the image capture mode (archive or tasking). |
| Host | A host is the image provider (satellite, aircraft, balloon, etc.) that offers |
| | access to data acquired by a producer |
| Producer | A producer is a company that owns airborne sensors or spaceborne |
| | platforms designated to image the Earth according to a specific set of |
| | requirements. The acquired geospatial data can be further distributed to |
| | various hosts. |
| Authenticate | Authenticate with the access token, which is generated from project |
| | credentials. |
| Data discovery | Browse the collections and data products available in the data platform |
| | list. |
| Data ordering | API can estimate the price in advance. If prior thresholds are set and met |
| | purchase of the data and order placement is done. |
| Data Delivery | After the order is placed, API-based monitoring of the order status will |
| | enable automatic asset downloads. An asset is a unique item associated |
| | with a successful order and it contains the downloadable geospatial |
| | dataset. |
| Processing and | Once downloaded into N5's AWS (Amazon Web Service) database and |
| Integration with | stored, the image processing ML module will be notified and will start |
| N5 ML Model | processing. Once identified, alerts will be sent to the dashboard. |

The ML model can be trained to extract a particular dataset if it is available, meets the proposed cost ranges, and can be optimized according to a threshold. Once identified, the data is downloaded and stored in the Amazon Web Service (AWS) database. In addition, the ML model can identify and analyze anomalies in historical image streams from satellite sources.

A variety of models have been used with SAR-based satellite images. Of these models are Convolutional Neural Networks (CNNs), which continue to be the most used models, with Generative Adversarial Networks (GANs) becoming more common. The potential for wildfire detection using satellite-based SAR images was highlighted in the trend-setting paper by Yifang Ban et al. They demonstrated the potential of SAR time series images with a deep learning framework for near real-time wildfire progression monitoring. In Ban's paper though, the fire is detected over the entire satellite image field, which is a very large area. In contrast, embodiments of the present invention use satellite image analysis of a specific region for fire detection, rather than the whole field of view of the satellite. The specific region is determined by the ground-based sensor network. The deep learning framework, based on a CNN, is developed to detect burnt areas automatically using every new SAR image acquired during the wildfires and by exploiting all available pre-fire SAR time series to characterize the temporal backscatter variations. Because of the unique features of SAR images, some exemplary embodiments disclosed herein develop ML models using SAR-based imagery.

The ML models in some embodiments can analyze sequences of satellite images for anomaly detection. For example, a deep learning-based prediction model (DeepPaSTL) is trained in a supervised fashion and learns the spatiotemporal characteristics of a quantity of interest (e.g., by predicting vegetation growth using aerial data as an example of a spatiotemporal field). While DeepPaSTL architecture is a promising starting point for wildfire prediction using satellite imagery, there are several research challenges. First, DeepPaSTL uses a large, supervised training dataset which may not be available for wildfire prediction. Thus, some embodiments herein may use semi-supervised methods to operate with limited data. Second, DeepPaSTL architecture only uses unimodal data (i.e., single-channel image input). As such, some embodiments herein can handle multimodal data (i.e., use several satellite bands). Third, DeepPaSTL is used to predict growth models over long periods of time (order of weeks) whereas embodiments herein adapt the algorithm to make predictions over shorter periods (order of min/hrs). Further, some embodiments herein use free satellite data available via NASA's Earthdata platform to train and validate data sets.

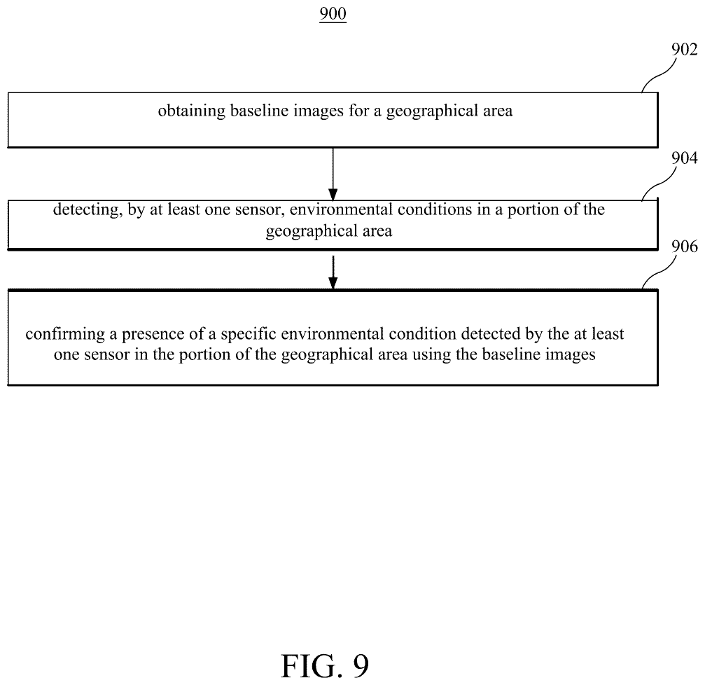

FIG. 9 illustrates a method 900 for performing a method of environmental condition detection, wherein the method comprises: obtaining (902) baseline images for a geographical area; detecting (904), by at least one sensor, environmental conditions in a portion of the geographical area; and confirming (906) a presence of a specific environmental condition detected by the at least one sensor in the portion of the geographical area using the baseline images. The method can further include obtaining further images for the portion of the geographical area; identifying one or more anomalies between the further images for the portion of the geographical area and the baseline images for the portion of the geographical area; and predicting where a fire will spread and/or the speed of the fire in the geographical area based on the identified one or more anomalies.

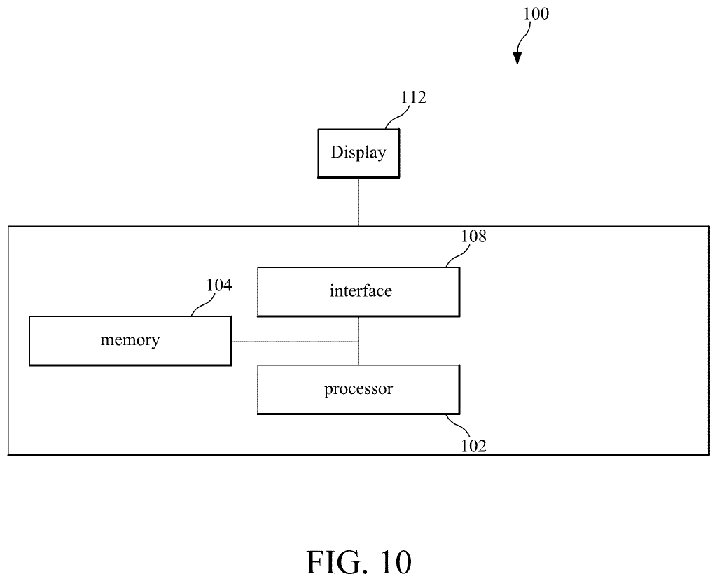

FIG. 10 shows a device 100 which can be used to execute instructions, collect information and process information associated with using satellite-sensor AI fusion to detect environmental conditions. The device 100 can include, for example, a processor 102, a memory 104, an interface 108, and a display 112. The interface 108 may be used for communicating with other portions of a computer, other components of an electronic device or external devices, including sending and receiving data. The processor 102 may be a combination of one or more of a microprocessor, controller, microcontroller, central processing unit, digital signal processor, application specific integrated circuit, field programmable gate array, or any other suitable computing device, resource, or combination of hardware, software and/or encoded logic operable to provide, either alone or in conjunction with other components, such as the primary and secondary memory. For example, the processor 102 may execute instructions stored in the memory 104. The display 112 can, for example, show an output associated with geolocations of environmental changes or anomalies.

The memory 104 may include any form of volatile or non-volatile computer readable memory including, without limitation, persistent storage, solid state memory, remotely mounted memory, magnetic media, optical media, RAM, read-only memory (ROM), removable media, or any other suitable local or remote memory component. The memory 104 may store any suitable instructions, data or information, including software and encoded logic, utilized by a computer and/or other electronic device. The memory 104 may be used to store any calculations made by processor 102 and/or any data received via interface 108.

The disclosed embodiments provide methods, systems, and devices for a sensing-satellite AI/ML fusion. It should be understood that this description is not intended to limit the invention. On the contrary, the embodiments are intended to cover alternatives, modifications and equivalents, which are included in the spirit and scope of the invention. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein. The methods or flowcharts provided in the present application may be implemented in a computer program, software or firmware tangibly embodied in a computer-readable storage medium for execution by a specifically programmed computer or processor.

What is claimed is:

1. A method for environmental condition detection, wherein the method comprises:
obtaining baseline images for a geographical area;
detecting, by at least one sensor, environmental conditions in a portion of the geographical area; and
confirming a presence of a specific environmental condition detected by the at least one sensor in the portion of the geographical area using the baseline images.

2. The method of claim 1, wherein the at least one sensor is mounted to an apparatus.

3. The method of claim 2, wherein the apparatus is a pole, a building, or a drone.

4. The method of claim 1, wherein the at least one sensor is located at least between 5 feet and 30 feet above a ground elevation of the portion of the geographical area.

5. The method of claim 1, wherein the baseline images are obtained from at least one satellite and the at least one satellite is a synthetic aperture radar (SAR) satellite.

6. The method of claim 1, wherein the step of confirming the presence of the specific environmental condition detected by the at least one sensor in the portion of the geographical area using the baseline images, further comprises:
obtaining further images for the portion of the geographical area; and
identifying one or more anomalies between the further images for the portion of the geographical area and the baseline images for the portion of the geographical area.

7. The method of claim 1, wherein the specific environmental condition is a flood, an earthquake, a landslide, arson, terrorist attacks, bombings, shootings, a fire, a biological attack, or a chemical spill.

8. The method of claim 6, wherein the specific environmental condition is a fire, the method further comprising:
predicting where the fire will spread and/or the speed of the fire in the geographical area based on the identified one or more anomalies.

9. The method of claim 1, wherein the portion of the geographical area is less than one acre.

10. The method of claim 1, wherein the at least one sensor is an orthogonal sensor.

11. The method of claim 1, further comprising a wind sensor.

12. The method of claim 1, wherein the method uses a machine learning (ML) model.

13. An apparatus for performing environmental condition detection, the apparatus comprising:
at least one processor;
a display; and
a memory,
wherein the at least one processor is configured to:
receive baseline images for a geographical area;
receive, from at least one sensor, detected environmental conditions in a portion of the geographical area; and
confirm a presence of a specific environmental condition detected by the at least one sensor in the portion of the geographical area using the baseline images.

14. The apparatus of claim 13, wherein the at least one sensor is mounted to a pole, a building, or a drone.

15. The apparatus of claim 13, wherein the at least one sensor is located at least between 5 feet and 30 feet above a ground elevation of the portion of the geographical area.

16. The apparatus of claim 13, wherein the baseline images are from at least one satellite and the at least one satellite is a synthetic aperture radar (SAR) satellite.

17. The apparatus of claim 13, wherein the processor is further configured to:
receive further images for the portion of the geographical area; and
identify one or more anomalies between the further images for the portion of the geographical area and the baseline images for the portion of the geographical area.

18. The apparatus of claim 17, wherein the specific environmental condition is a fire, and the processor is further configured to:
predict where a fire will spread and/or the speed of the fire in the geographical area based on the identified one or more anomalies.

19. The apparatus of claim 13, wherein the portion of the geographical area is less than one acre.

20. The apparatus of claim 13, wherein the at least one sensor is an orthogonal sensor.

21. The apparatus of claim 13, wherein the processor is further configured to: receive data from a wind sensor located in a portion of the geographical area.

22. The apparatus of claim 13, wherein the processor is configured to operate using a machine learning (ML) model.
